(19) United States
(12) Patent Application Publication
(10) Pub. No.: US 2007/0237165 A1
(43) Pub. Date: Oct. 11, 2007

(54) DISPLAYING SYSTEM WITH DISTRIBUTOR FUNCTION

(76) Inventor: Ching-Yueh Chiang, Kweishan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/564,925

(22) Filed: Nov. 30, 2006

(30) Foreign Application Priority Data
Apr. 7, 2006 (TW) 095112293

(51) Int. Cl. H04L 12/56

(52) U.S. Cl. 370/419

(57) ABSTRACT

The invention provides a displaying system with distributor function. The displaying system, according to the invention, includes two bi-directional ports, two switch devices, and a signal processing device. Each of the switch devices has three terminals, two of which are coupled to the bi-directional ports, and the other one of which is coupled to the signal processing device. When a signal is inputted at one of the bi-directional ports, the signal is transmitted to the signal processing device and meanwhile, to the other bi-directional port for signal output.

### BACKGROUND OF THE INVENTION

1. Field of the Invention

The present invention relates to a displaying system and a signal transmitting method thereof. In particular, the signal ports of the displaying system are bi-directional, and the displaying system can output an input signal at one of the signal ports by a method for transmitting the input signal inputted at the other signal port.

2. Description of the Prior Art

In the scope of the usage of monitors, the need for simultaneously displaying images on several monitors continues to increase, especially for several monitors to display the same image at the same time. For example, in a store that sells monitor, the same signal needs to be inputted to every monitor, so as to allow the consumers to compare the different monitors; in a business promotional activity, there is also a need for inputting the same signal to several monitors to enhance the advertising effect. Currently, this need is satisfied with a simple Y-shaped adaptor or a distributor. However, using a Y-shaped adaptor could cause serious signal decay, and using a distributor could not only increase the cost of the hardware but also make the line configuration and the management more difficult. In addition, though monitors of the prior art have signal transmitting ports, which are often bi-directionally, each of the signal transmitting ports is only used as an unidirectional port. For example, the signal transmitting port is only designed for signal input or signal output, which lacks flexibility; therefore, the monitors need more signal transmitting ports, including signal input ports and signal output ports.

Accordingly, the primary scope of the invention provides a displaying system with distributor function. The signal ports of the displaying system are bi-directional, and the displaying system can output an input signal at one of the signal ports by a method for transmitting the input signal inputted at the other signal port so that each signal port can flexibly be a signal input port or a signal output port according to the actual need, so as to solve the problem mentioned above.

### SUMMARY OF THE INVENTION

One scope of the invention provides a displaying system with distributor function, which has bi-directional signal ports.

Another scope of the invention provides a signal transmitting method, which allows the displaying system to be capable of outputting an input signal.

According to a preferred embodiment, a displaying system includes a first bi-directional port, a second bi-directional port, a first switch device, a second switch device, and a signal processing device. The first switch device has a first control terminal, a first terminal coupled to the first bi-directional port, a second terminal coupled to the second bi-directional port, and a third terminal. By controlling the first control terminal, the connection between the first terminal and the third terminal or between the second terminal and the third terminal is enabled. The second switch device has a second control terminal, a fourth terminal coupled to the first bi-directional port, a fifth terminal coupled to the second bi-directional port, and a sixth terminal coupled to the third terminal of the first switch device. By controlling the second control terminal, the connection between the fourth terminal and the sixth terminal or between the fifth terminal and the sixth terminal is enabled. The signal processing device processes a signal, and it is coupled to the third terminal of the first switch device.

Therein, when the first control terminal of the first switch device enables the connection between the first terminal and the third terminal, and the second control terminal of the second switch device enables the connection between the fifth terminal and the sixth terminal, the signal inputted at the first bi-directional port is transmitted through the first terminal and the third terminal to the signal processing device; furthermore, the signal is transmitted through the first terminal, the third terminal, the sixth terminal, and the fifth terminal to the second bi-directional port to be outputted. when the first control terminal of the first switch device enables the connection between the second terminal and the third terminal, and the second control terminal of the second switch device enables the connection between the fourth terminal and the sixth terminal, the signal inputted at the second bi-directional port is transmitted through the second terminal and the third terminal to the signal processing device; furthermore, the signal is transmitted through the second terminal, the third terminal, the sixth terminal, and the fourth terminal to the first bi-directional port to be outputted.

Besides, the displaying system further comprises a signal adjusting device, which has an input terminal coupled to the third terminal of the first switch device and an output terminal coupled to the sixth terminal of the second switch device. The signal adjusting device adjusts the signal transmitted from the first bi-directional port to the second bi-directional port or transmitted from the second bi-directional port to the first bi-directional port, so as to enhance the quality of the signal.

Therefore, according to the displaying system of the invention, not only are the signal ports of the displaying system bi-directional so that each signal port could be flexibly used as a signal input ports or a signal output ports according to the actual need, but the displaying system could also output an input signal to provide a distributor function by transmitting the input signal as described above. Comparing with the prior art, the displaying system according to the invention could effectively reduce the cost of the configuration and the difficulty of the management.

The advantage and spirit of the invention may be further understood by the following recitations together with the appended drawings.

### BRIEF DESCRIPTION OF THE APPENDED DRAWINGS

FIG. 1A is a function block diagram illustrating a displaying system 1 according to a preferred embodiment of the invention in which a signal S is inputted at a first bi-directional port 13 of the displaying system 1.

FIG. 1B is a function block diagram also illustrating the displaying system 1 according to the preferred embodiment of the invention in which the signal S is inputted at a second bi-directional port 14 of the displaying system 1.

FIG. 2 is a function block diagram illustrating a displaying system 1, according to another preferred embodiment of the invention, which further includes a signal adjusting device 16.

FIG. 3 is a flow chart showing a signal transmitting method according to a preferred embodiment of the invention.

FIG. 4 is a schematic diagram illustrating a practical application according to the displaying system of the present invention.

### DETAILED DESCRIPTION OF THE INVENTION

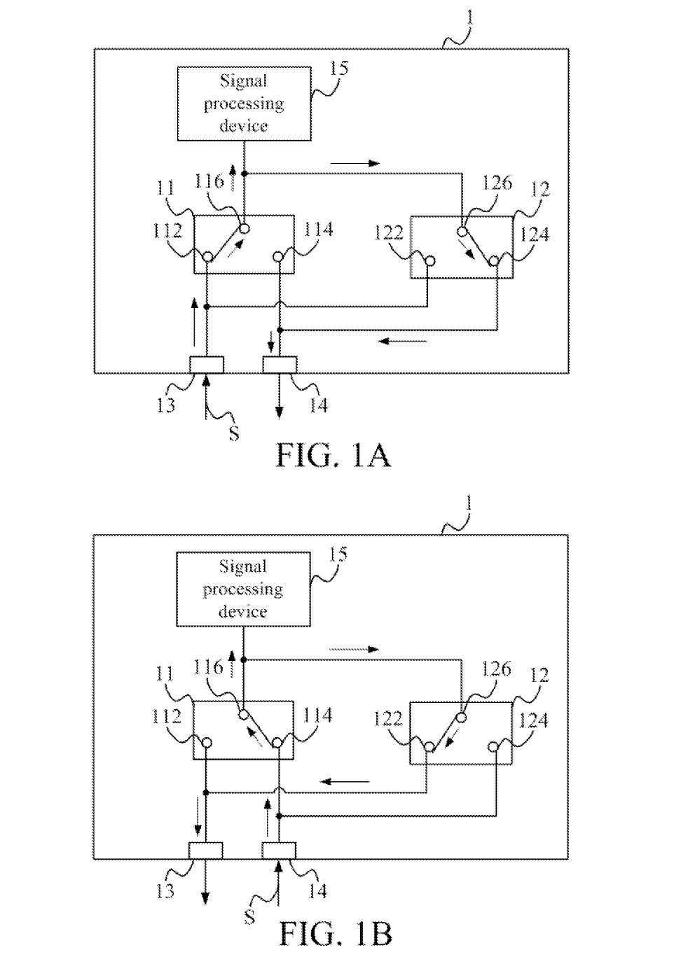

Referring to FIG. 1A and FIG. 1B, FIG. 1A and FIG. 1B are function block diagrams illustrating the displaying system 1 according to a preferred embodiment of the invention. FIG. 1A is a function block diagram in which a signal S is inputted at a first bi-directional port 13. FIG. 1B is a function block diagram in which a signal S is inputted at a second bi-directional port 14. The displaying system 1 includes the first bi-directional port 13, the second bi-directional port 14, a first switch device 11, a second switch device 12, and a signal processing device 15. The first switch device 11 has a first terminal 112 coupled to the first bi-directional 13, a second terminal 114 coupled to the second bi-directional 14, a third terminal 116, and a first control terminal, which is not shown in FIG. 1A and FIG. 1B. The connection between the first terminal 112 and the third terminal 116 or between the second terminal 114 and the third terminal 116 is enabled by controlling the first control terminal. The second switch device 12 has a fourth terminal 122 coupled to the first bi-directional port 13, a fifth terminal 124 coupled to the second bi-directional port 14, a sixth terminal 126 coupled to the third terminal 116 of the first switch device 11, and a second control terminal, which is not shown in FIG. 1A and FIG. 1B. The connection between the fourth terminal 122 and the sixth terminal 126 or between the fifth terminal 124 and the sixth terminal 126 is enabled by controlling the second control terminal. The signal processing device 15 is coupled to the third terminal 116. The signal processing device 15 processes the signal S for the displaying system 1 to display the signal S processed by the signal processing device 15.

As shown in FIG. 1A, when the signal S is inputted at the first bi-directional port 13, by controlling the first control terminal to enable the connection between the first terminal 112 and the third terminal 116 and controlling the second control terminal to enable the connection between the fifth terminal 124 and the sixth terminal 126, the signal S is transmitted through the first terminal 112 and the third terminal 116 to the signal processing device 15; furthermore, the signal S is transmitted through the first terminal 112, the third terminal 116, the sixth terminal 126, and the fifth terminal 124 to the second bi-directional port 14 to be outputted. As shown in FIG. 1B, when the signal S is inputted at the second bi-directional port 14, by controlling the first control terminal to enable the connection between the second terminal 114 and the third terminal 116 and controlling the second control terminal to enable the connection between the fourth terminal 122 and the sixth terminal 126, the signal S is transmitted through the second terminal 114 and the third terminal 116 to the signal processing device 15; furthermore, the signal S is transmitted through the second terminal 114, the third terminal 116, the sixth terminal 126, and the fourth terminal 122 to the first bi-directional port 13 to be outputted.

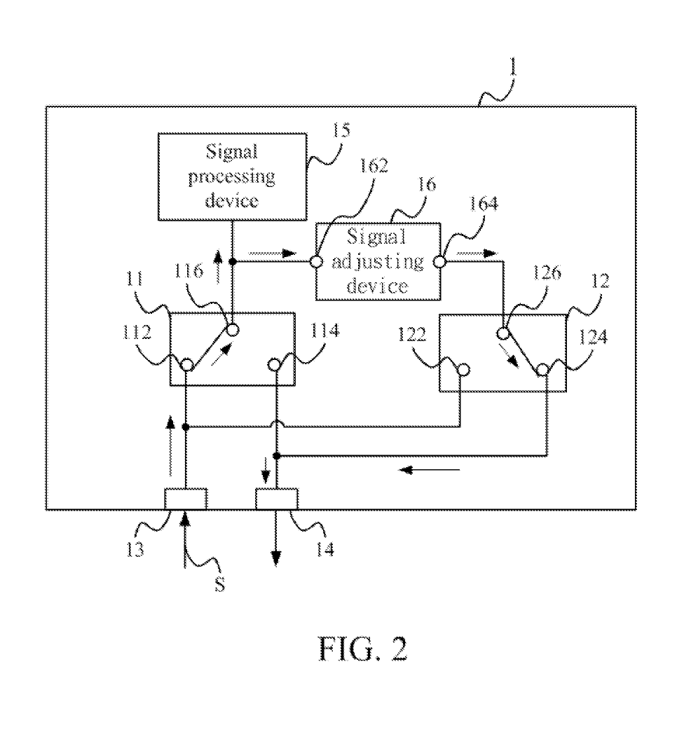

Referring to FIG. 2, FIG. 2 is a function block diagram illustrating a displaying system 1, according to another preferred embodiment of the invention. The displaying system 1 further includes a signal adjusting device 16, which has an input terminal 162 coupled to the third terminal 116 of the first switch 11 and an output terminal 164 coupled to the sixth terminal 126 of the second switch 12. The signal adjusting device 16 adjusts the signal S transmitted from the first bi-directional port 13 to the second bi-directional 14 or transmitted from the second bi-directional port 14 to the first bi-directional 13. The signal adjusting device 16 could enhance the decayed signal S or filter the noise within the signal S. When the signal S is inputted at the first bi-directional port 13 and outputted at the second bi-directional port 14, the signal S inputted at the first bi-directional port 13 is directly transmitted to the signal processing device 15. However, the signal S is first adjusted by the signal adjusting device 16 before being transmitted to the second bi-directional port 14, so as to solve the signal decay and other problems possibly induced during the transmission. Similarly, when the signal S is inputted at the second bi-directional port 14 and outputted at the first bi-directional port 13, the signal S inputted at the second bi-directional port 14 is directly transmitted to the signal processing device 15. However, the signal S is first adjusted by the signal adjusting device 16 before being transmitted to the first bi-directional port 13, so as to solve the signal decay and other problems possibly induced during the transmission.

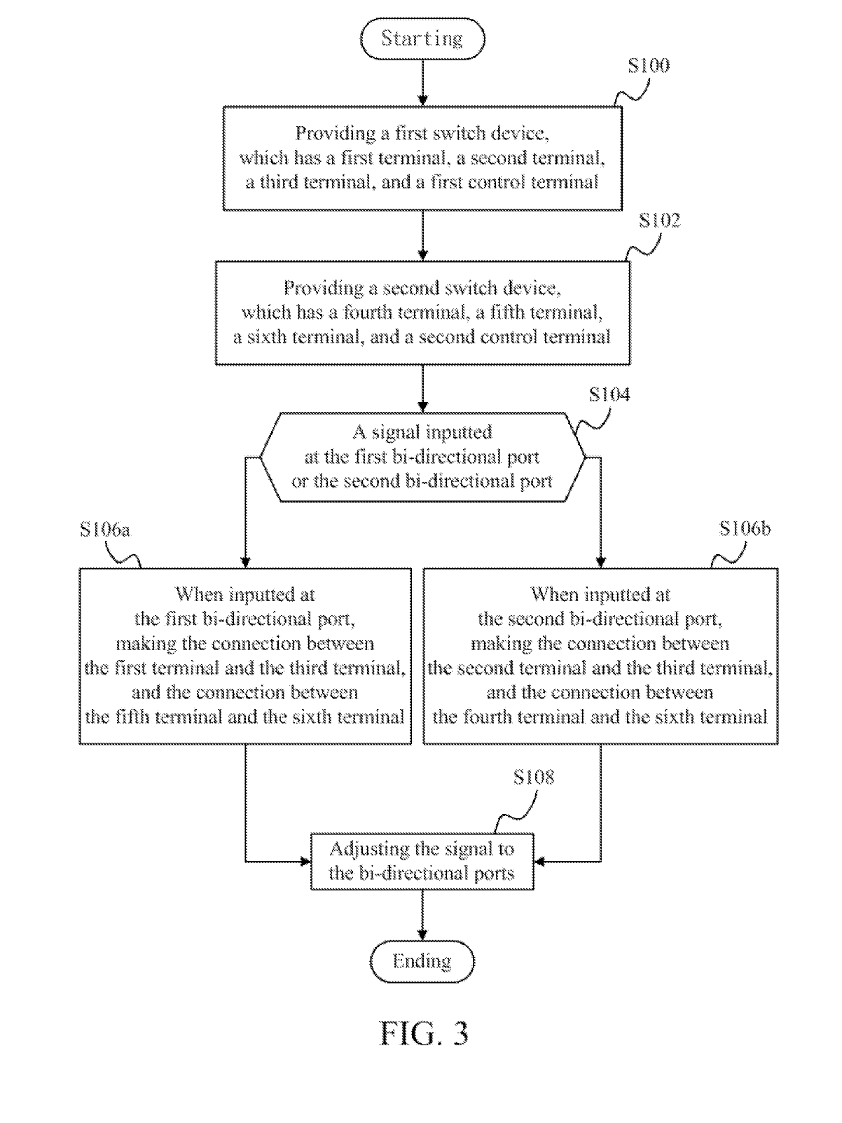

Referring to FIG. 3 together with FIG. 1A and FIG. 1B, FIG. 3 is a flow chart showing a signal transmitting method according to a preferred embodiment of the invention. The signal transmitting method, according to the invention, transmits a signal S inputted at the first bi-directional port 13 of a displaying system 1 to a second bi-directional port 14 of the displaying system 1 or transmits the signal S inputted at the second bi-directional port 14 of the displaying system 1 to the first bi-directional port 13 of the displaying system 1. Meanwhile, the signal S is transmitted to a signal processing device 15 for the displaying system to display the signal S processed by the signal processing device 15. According to the above preferred embodiment, the signal transmitting method of the invention is described as follows.

According to the signal transmitting method, as shown in step S100 of FIG. 3, a first switch device 11 is provided first. The first switch device 11 has a first terminal 112 coupled to the first bi-directional port 13, a second terminal 114 coupled to the second bi-directional port 14, a third terminal 116 coupled to the signal processing device 15, and a first control terminal, which is not shown in FIG. 1A, FIG. 1B, and FIG. 2. The first control terminal is used to enable the connection between the first terminal 112 and the third terminal 116 or between the second terminal 114 and the third terminal 116. Furthermore, a second switch device 12 is also provided. The second switch device 12 has a fourth terminal 122 coupled to the first bi-directional port 13, a fifth terminal 124 coupled to the second bi-directional port 14, a sixth terminal 126 coupled to the third terminal 116 of the first switch device 11, and a second control terminal, which is not shown in FIG. 1A, FIG. 1B, and FIG. 2. The second control terminal is used to enable the connection between the fourth terminal 122 and the sixth terminal 126 or between the fifth terminal 124 and the sixth terminal 126, as shown in step S102 of FIG. 3.

According the signal transmitting method, the signal S can be inputted at the first bi-directional port 13 and transmitted to the second bi-directional port 14 to be outputted, or inputted at the second bi-directional port 14 and transmitted to the first bi-directional port 13 to be outputted, both of which make different switch paths, as shown in step S104 of FIG. 3. As shown in step S106a of FIG. 3, when the signal S is inputted at the first bi-directional device 13, by controlling the first control terminal to enable the connection between the first terminal 112 and the third terminal 116 and controlling the second control terminal to enable the connection between the fifth terminal 124 and the sixth terminal 126, the signal S is transmitted through the first terminal 112 and the third terminal 116 to the signal processing device 15; furthermore, the signal S is transmitted through the first terminal 112, the third terminal 116, the sixth terminal 126, and the fifth terminal 124 to the second bi-directional port 14 to be outputted, as shown in FIG. 1A. After the signal S is outputted at the second bi-directional port 14, the signal S may be further transmitted to other displaying systems.

Similarly, as shown in step S106b of FIG. 3, when the signal S is inputted at the second bi-directional port 14, by controlling the first control terminal to enable the connection between the second terminal 114 and the third terminal 116 and controlling the second control terminal to enable the connection between the fourth terminal 122 and the sixth terminal 126, the signal S is transmitted through the second terminal 114 and the third terminal 116 to the signal processing device 15; furthermore, the signal S is transmitted through the second terminal 114, the third terminal 116, the sixth terminal 126, and the fourth terminal 122 to the first bi-directional port 13 to be outputted, as shown in FIG. 1B. After the signal S is outputted at the first bi-directional port 13, the signal S may be further transmitted to other displaying systems.

In addition, the signal S, which is transmitted from the first bi-directional port 13 to the second bi-directional port 14 or from the second bi-directional port 14 to the first bi-directional port 13, could be adjusted to enhance the quality of the signal S, as shown in step S108 of FIG. 3. The adjustment of the signal could enhance the decayed signal S or filter the noise within the signal S.

Therefore, the signal S inputted at the first bi-directional port 13 is not only transmitted to the signal processing device 15 for displaying but also transmitted to the second bi-directional port 14 for other displaying systems as a signal source, so as to fulfill a signal-distributing function, and vice versa.

According to the preferred embodiment of the invention, the signal S could be a digital signal or an analog signal. The first bi-directional port 13 and the second bi-direction port 14 both comply with a DVI-I specification, a DVI-D specification, or a D-sub specification. Besides, when the first bi-directional port 13 and the second bi-directional port 14 are both inputted with signals, by controlling the first control terminal and the second control terminal, the second switch device 12 will be disabled, and the first switch device 11 will be treated as a general switch to select one of the signals.

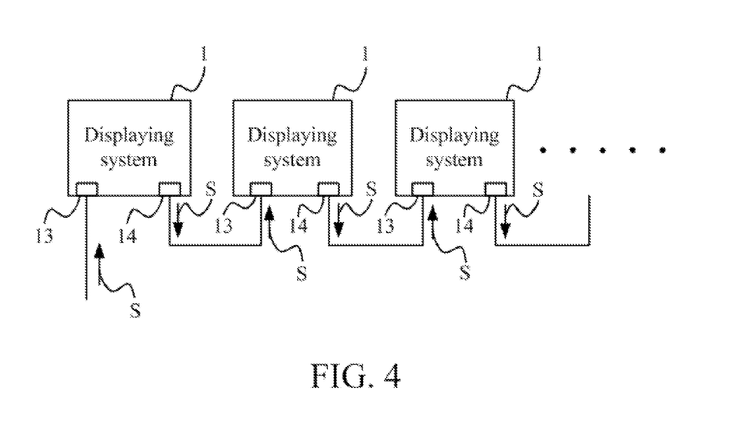

Therefore, according to the displaying system of the invention, not only are the signal ports of the displaying system bi-directional, but the displaying system could also output an input signal to provide a distributor function by transmitting the input signal as described above. In actual application, stringing several displaying systems together according to the invention could arrive at the same effect as using a distributor according to the prior art, but the cost of the configuration and the difficulty of the management could be effectively reduced, as shown in FIG. 4.

With the recitations of the preferred embodiment above, the features and spirits of the invention will be hopefully well described. However, the scope of the invention is not restricted by the preferred embodiment disclosed above. The objective is that all alternative and equivalent arrangements are hopefully covered in the scope of the appended claims of the invention. Accordingly, the above disclosure should be construed as limited only by the metes and bounds of the appended claims.

What is claimed is:

1. A displaying system, comprising:
a first bi-directional port;
a second bi-directional port;
a first switch device having a first control terminal, a first terminal coupled to the first bi-directional port, a second terminal coupled to the second bi-directional port, and a third terminal, the first control terminal enabling the connection between the first terminal and the third terminal or between the second terminal and the third terminal;
a second switch device having a second control terminal, a fourth terminal coupled to the first bi-directional port, a fifth terminal coupled to the second bi-directional port, and a sixth terminal coupled to the third terminal of the first switch device, the second control terminal enabling the connection between the fourth terminal and the sixth terminal or between the fifth terminal and the sixth terminal; and
a signal processing device, coupled to the third terminal of the first switch device, for processing a signal;
wherein, by controlling the first switch device and the second switch device, the signal is inputted at the first bi-directional port, transmitted to the signal processing device to be processed, and then transmitted to the second bi-directional port to be outputted; or inputted at the second bi-directional port, transmitted to the signal processing device to be processed, and then transmitted to the first bi-directional port to be outputted.

2. The displaying system of claim 1, wherein when the first control terminal of the first switch device enables the connection between the first terminal and the third terminal, and the second control terminal of the second switch device enables the connection between the fifth terminal and the sixth terminal, the signal inputted at the first bi-directional port is transmitted through the first terminal and the third terminal to the signal processing device, and then transmitted through the first terminal, the third terminal, the sixth terminal, and the fifth terminal to the second bi-directional port.

3. The displaying system of claim 1, wherein when the first control terminal of the first switch device enables the connection between the second terminal and the third terminal, and the second control terminal of the second switch device enables the connection between the fourth terminal and the sixth terminal, the signal inputted at the second bi-directional port is transmitted through the second terminal and the third terminal to the signal processing device, and then transmitted through the second terminal, the third terminal, the sixth terminal, and the fourth terminal to the first bi-directional port.

4. The displaying system of claim 1, further comprising a signal adjusting device for adjusting the signal transmitted from the first bi-directional port to the second bi-directional port or the signal transmitted from the second bi-directional port to the first bi-directional port, the signal adjusting device having an input terminal coupled to the third terminal of the first switch device, and an output terminal coupled to the sixth terminal of the second switch device.

5. The displaying system of claim 1, wherein the first bi-directional port and the second bi-directional port both comply with a DVI-I specification.

6. The displaying system of claim 1, wherein the first bi-directional port and the second bi-directional port both comply with a DVI-D specification.

7. The displaying system of claim 1, wherein the first bi-directional port and the second bi-directional port both comply with a D-Sub specification.

8. A signal transmitting method for transmitting a signal inputted at a first bi-directional port of a displaying system to a second bi-directional port of the displaying system, or transmitting the signal inputted at the second bi-directional port of the displaying system to the first bi-directional port of the displaying system, said method comprising the steps of:
(a) providing a first switch device having a first control terminal, a first terminal coupled to the first bi-directional port, a second terminal coupled to the second bi-directional port, and a third terminal, the first control terminal enabling the connection between the first terminal and the third terminal or between the second terminal and the third terminal;
(b) providing a second switch device having a second control terminal, a fourth terminal coupled to the first bi-directional port, a fifth terminal coupled to the second bi-directional port, and a sixth terminal coupled to the third terminal of the first switch device, the second control terminal enabling the connection between the fourth terminal and the sixth terminal or between the fifth terminal and the sixth terminal; and
(c) controlling the first switch device and the second switch device by the first control terminal and the second control terminal, respectively, such that the signal inputted at the first bi-directional port is transmitted to a signal processing device, and then transmitted to the second bi-directional port, or the signal inputted at the second bi-directional port is transmitted to the signal processing device, and then transmitted to the first bi-directional port.

9. The signal transmitting method of claim 8, wherein in step (c), the first control terminal of the first switch device is controlled to make the connection between the first terminal and the third terminal and the second control terminal of the second switch device is controlled to make the connection between the fifth terminal and the sixth terminal, such that the signal inputted at the first bi-directional port is transmitted through the first terminal and the third terminal to the signal processing device, and then transmitted through the first terminal, the third terminal, the sixth terminal, and the fifth terminal to the second bi-directional port.

10. The signal transmitting method of claim 9, wherein in step (c), the signal inputted at the first bi-directional port is adjusted and then transmitted to the second bi-directional port.

11. The signal transmitting method of claim 8, wherein in step (c), the first control terminal of the first switch device is controlled to enable the connection between the second terminal and the third terminal and the second control terminal of the second switch device is controlled to enable the connection between the fourth terminal and the sixth terminal, such that the signal inputted at the second bi-directional port is transmitted through the second terminal and the third terminal to the signal processing device, and then transmitted through the second terminal, the third terminal, the sixth terminal, and the fourth terminal to the first bi-directional port.

12. The signal transmitting method of claim 11, wherein in step (c), the signal inputted at the second bi-directional port is adjusted and then transmitted to the first bi-directional port.

13. The signal transmitting method of claim 8, wherein the first bi-directional port and the second bi-directional port both comply with a DVI-I specification.

14. The signal transmitting method of claim 8, wherein the first bi-directional port and the second bi-directional port both comply with a DVI-D specification.

15. The signal transmitting method of claim 8, wherein the first bi-directional port and the second bi-directional port both comply with a D-Sub specification.
